(19) United States
(12) Patent Application Publication
(10) Pub. No.: US 2025/0140545 A1
(43) Pub. Date: May 1, 2025

(54) OPTOMECHANICAL TRANSDUCTION SYSTEM WITH IMPROVED DETECTION

(71) Applicant: COMMISSARIAT A L'ENERGIE ATOMIQUE ET AUX ENERGIES ALTERNATIVES, Paris (FR)

(72) Inventors: Wioletta TRZPIL, Grenoble Cedex 09 (FR); Marc SANSA PERNA, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/929,783

(22) Filed: Oct. 29, 2024

(30) Foreign Application Priority Data
Oct. 30, 2023 (FR) 2311817

(51) Int. Cl. H01J 49/28; G01N 21/17

(52) U.S. Cl. CPC H01J 49/282; G01N 21/1702

(57) ABSTRACT

An optomechanical system for transducing an optical intensity modulation movement including an optical detector and a mechanical sensor including a mobile mass, of which a receiving surface is intended to receive an external mechanical urging, and an excitation device. The excitation device is configured to vibrate the mobile mass along an excitation direction at at least one of its resonance frequencies. The vibration of the mobile mass is disrupted by the external mechanical urging, and modifies an evanescent field of the optical detector. The mobile mass has an interaction region facing the optical detector, as well as a second region, respectively having, projecting along a plane perpendicular to the excitation direction, an interaction surface area S₁₁₁ and a second surface area S₁₁₂, with S₁₁₂<S₁₁₁.

### TECHNICAL FIELD

The present invention relates to mechanical detection using resonant micromechanical and/or nanomechanical structures. It has, as a particularly advantageous application, gravimetric detection, in particular, for mass spectrometry.

### PRIOR ART

Mass spectrometry is an analysis technique, making it possible, in particular, to determine the molecular mass of species within compounds. Mass spectrometry can be implemented by different techniques, among which techniques using resonant micro and/or nanomechanical systems. As illustrated in FIGS. 1A and 1B, such systems comprise a mobile mass 110 excited at its resonance frequency. The species to be analysed is deposited on the mobile mass 110, which has the effect of modifying the mass of the mobile mass 110. This has the effect of modifying the resonance frequency of the mobile mass 110, this modification being able to correlated to the mass of the species.

Detecting the resonance frequency of the mobile mass is done typically using an optical detector 200 comprising an optical resonator 220. The detection system is thus configured, such that the vibration movement of the mobile mass 110 in the proximity of the optical resonator 220 modifies the optical properties of the latter.

Analysing the compound is therefore very dependent on the optomechanical coupling between the mobile mass 110 and the optical resonator 220, as well as the interaction zone of the mobile mass 110 with the optical resonator 220. In particular, the weaker this interaction zone is, the weaker the signal conveying the variations of the resonance frequency is.

Moreover, the mass resolution of the detection system very highly depends on the mass of the mobile mass 110: a mass which is too high indeed impedes its mobility and degrades the accuracy of the analysis, i.e. increases the lowest detectable analysis weight.

These two observations lead to two opposite sizing recommendations for the mobile mass, as indeed, for a conventional parallelepiped-shaped mobile mass, increasing the dimensions of the interaction zone of the mobile mass 110 with the optical resonator 220 returns to increasing the volume of the mobile mass 110 and therefore, with identical material, its mass.

An aim of the present invention is therefore to propose a solution making it possible to improve the mechanical detection, using resonant micromechanical and/or nanomechanical structures.

### SUMMARY

To achieve this aim, a first aspect of the invention relates to an optomechanical system for transducing an optical phase shift movement comprising:
a. A mechanical sensor comprising a mobile mass of which a surface, called receiving surface, is intended to receive one or more particles to be detected and to undergo the weight of the particle(s) to be detected, and an excitation device,
b. An optical detector.

The excitation device is configured to vibrate the mobile mass along a first direction called excitation direction at at least one of its resonance frequencies, the vibration of the mobile mass being modified by the weight of the particle(s) to be detected, the vibration of the mobile mass modifying an evanescent field of the optical detector. The mobile mass has a first region called interaction region facing the optical detector.

The system is characterised in that the mobile mass comprises at least one second region located outside of the interaction region, the interaction region and the second region respectively having, projecting along a plane perpendicular to the excitation direction, called vertical plane, an interaction surface area S₁₁₁ and a second surface area S₁₁₂, the second region being such that S₁₁₂<S₁₁₁.

The presence of the second region and this aspect ratio between the second region and the interaction region make it possible to reduce the mass of the mobile mass and therefore guarantee a high mass resolution, while optimising the optomechanical interaction surface area between the mechanical sensor and the optical detector.

In this way, both the detection of particles by the mobile mass and the transmission of detection information of the mobile mass to the optical detector are optimised. The mechanical detection of the particles is thus improved.

### BRIEF DESCRIPTION OF THE FIGURES

The aims, objectives, as well as the features and advantages of the invention will best emerge from the detailed description of an embodiment of the latter which is illustrated by the following accompanying drawings, in which:

FIGS. 1A and 1B are schematic representations of a detection system according to the prior art, comprising a mechanical sensor and an optical detector. FIGS. 1A and 1B represent, among others, an example of an optical detector being able to be integrated in a detection system according to the invention. FIG. 1A illustrates a case in which the mobile mass is immobile.

FIG. 1B illustrates a case in which the mobile mass vibrates.

FIG. 2 is a cross-sectional view of the system according to the invention.

FIGS. 3A and 3B are top views of the system according to the invention, more specifically according to an embodiment in which the interaction region has a width greater than the second region.

FIG. 3B illustrates an embodiment in which the mobile mass has an excitation region having a height greater than that of the second region.

FIG. 4 illustrates an embodiment of the invention in which the mobile mass is connected to anchoring regions by articulations making it possible to limit the non-linearity of its vibration.

FIG. 5 represents a detection system according to the invention comprising a plurality of mobile masses.

The drawings are given as examples and are not limiting of the invention. They constitute principle schematic representations intended to facilitate the understanding of the invention and are not necessarily to the scale of practical applications. In particular, the dimensions are not representative of reality.

### DETAILED DESCRIPTION

Before starting a detailed review of embodiments of the invention, below optional features are stated, which can optionally be used in association or alternatively:

Advantageously, S₁₁₁>2*S₁₁₂, preferably S₁₁₁>3*S₁₁₂, preferably S₁₁₁>5*S₁₁₂.

Preferably, along a third direction perpendicular to a plane, called excitation plane, into which the receiving surface mainly extends, the interaction region has a height H₁₁₁ and the second region has a height H₁₁₂, with H₁₁₁>H₁₁₂, preferably H₁₁₁>2*H₁₁₂, preferably H₁₁₁>5*H₁₁₂. Generally, advantageously, the height H₁₁₁ of the interaction region is substantially the same as the height H₂₂₀ of the optical detector, also measured along the third direction perpendicular to the excitation plane. H₂₂₀ is typically substantially equal to 220 nm. Thus, preferably, H₁₁₁ is substantially equal to 220 nm.

Preferably, along a third direction perpendicular to a plane, called excitation plane, into which the receiving surface mainly extends, the second region has a height H₁₁₂, with H₁₁₂≤200 nm, preferably H₁₁₂≤60 nm, preferably H₁₁₂≤30 nm.

Advantageously, along a second direction parallel to the vertical plane and perpendicular to the excitation direction, the interaction region has a width l₁₁₁ and the second region has a width l₁₁₂, with l₁₁₁>1.5*l₁₁₂, preferably l₁₁₁>2*l₁₁₂.

Advantageously, along the excitation direction, the mobile mass has a length L₁₁₀ and the interaction region has a length L₁₁₁, with L₁₁₁≤0.1*L₁₁₀, preferably L₁₁₁≤0.03*L₁₁₀. This makes it possible that the interaction region does not extend too much within the mobile mass. Thus, the mass of the mobile mass is sufficiently hardly impacted by the presence of the interaction region. The mass of the mobile mass remains sufficiently low, such that the detection is optimal. For example, L₁₁₀=1.5 μm and L₁₁₁=0.15 μm or L₁₁₀=1.5 μm and L₁₁₁=0.1 μm.

According to a preferred embodiment, the interaction region has an interaction face facing a secondary interaction face of the optical detector, the interaction face and the secondary interaction face having identical shapes projecting into a plane perpendicular to the vertical plane and parallel to the excitation direction, called horizontal plane. This makes it possible to improve the optomechanical interaction between the interaction region and the secondary laser radiation.

According to an example, the interaction face and the secondary interaction face have a circular arc shape, projecting into the horizontal plane.

According to a preferred embodiment, the mobile mass has an excitation region facing the excitation device, the excitation region having, projecting along the plane perpendicular to the excitation direction, an excitation surface area S₁₁₃ with S₁₁₃>S₁₁₂. This makes it possible to increase the interaction between the mobile mass and the excitation device and therefore to optimise the electrostatic excitation in the case of an excitation by an electrode.

Preferably, the interaction region and the excitation region have substantially identical volumes, and preferably, substantially identical shapes. Preferably, along a third direction perpendicular to a plane, called excitation plane, into which the receiving surface mainly extends, the excitation region has a height H₁₁₃ substantially equal to the height H₁₄₀ of the excitation device, also measured along the third direction perpendicular to the excitation plane. H₁₄₀ is typically substantially equal to 220 nm. Thus, preferably, H₁₁₃ is substantially equal to 220 nm. Moreover, according to a preferred embodiment, H₁₁₁=H₁₁₃.

Preferably, the interaction region and the excitation region are located on either side of the second region. This makes it possible to balance the mobile mass. Combined with the feature according to which the volumes of the interaction region and of the excitation region are identical, the balancing is optimal. More specifically, this makes it possible that the centre of gravity of the mobile mass is in the middle of its length L₁₁₀ along the excitation direction.

According to a preferred example, the mobile mass is connected to anchoring regions through articulations configured to reduce a non-linearity of the vibration of the mobile mass. This makes it possible, with respect to embedded guided anchorings commonly used in NOEMS (nano-opto-electro-mechanical systems) devices, to limit, even remove, the non-linear effects on the movement of the mobile mass. Thus, the movement of the mobile mass is maximised, and the detection signal of the device is improved.

According to an embodiment, the excitation device is an electrode, applying on the mobile mass, an electrostatic force at the resonance frequency(ies) of the mobile mass.

The terms “substantially”, “about”, “around” mean, when they relate to a value, “plus or minus 10%” of this value or, when they relate to an angular orientation, “plus or minus 10°” of this orientation. Thus, a direction substantially normal to a plane means a direction having an angle of 90±10° with respect to the plane.

An XYZ system represented in the figures will be used in the detailed description below.

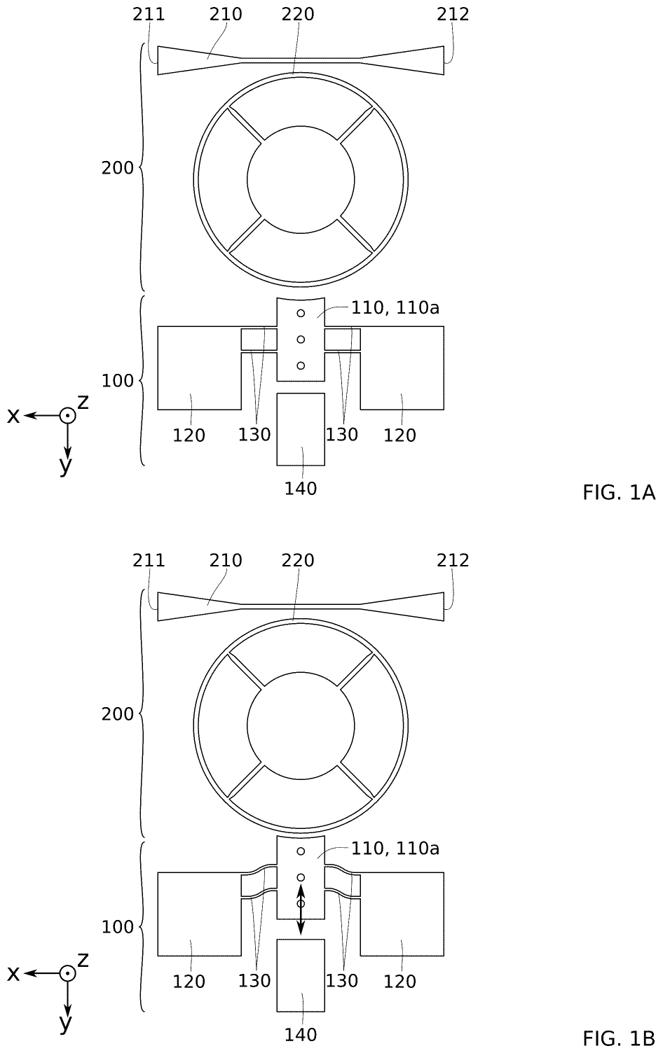

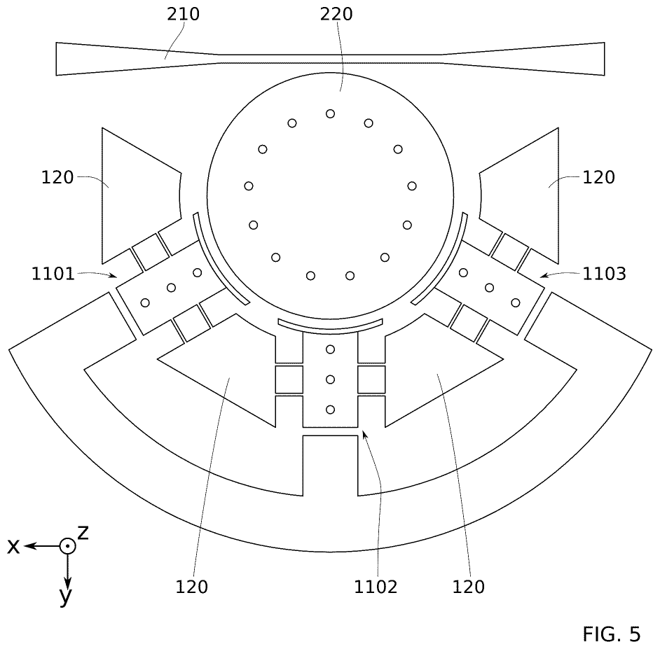

The system 1 according to different embodiments of the invention will now be described in reference to FIGS. 1 to 5.

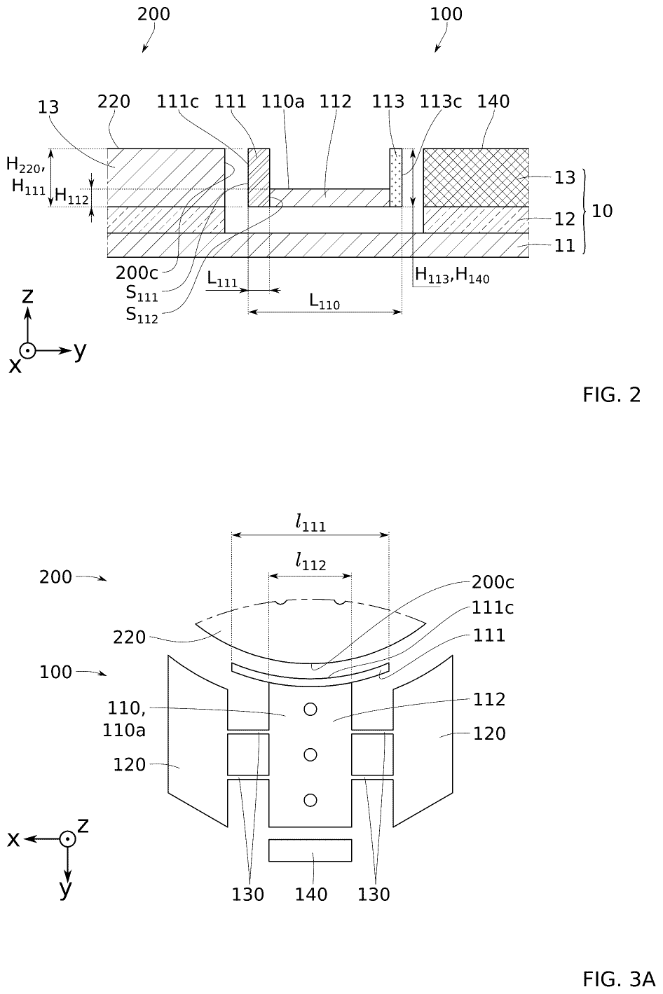

As illustrated in FIG. 2, the elements composing the system 1 can be formed in one same substrate 10, or, for some, can have been deposited on this substrate 10. Certain elements can be formed during same manufacturing steps and be constituted of the same material, for example, silicon or polysilicon. The substrate 10 can, for example, comprise a support substrate 11, typically, silicon-based. A buried oxide layer 12 and an active layer 13 can cover the support substrate 11, the buried oxide layer 12 located between the support 15 substrate 11 and the active layer 13. The different elements of the system 1 described above are advantageously formed in the active layer 13 by conventional microelectronic methods.

The mechanical sensor 100 comprises a mobile mass 110. The mobile mass 110 is typically connected to anchoring regions 120 being made of one single piece with the support substrate 11. The mobile mass is connected to the anchoring regions 120 through branches 130 called fixing branches. These fixing branches 130 are deformable, the mobile 20 mass 110 is thus capable of being moved relative to the support substrate 11.

The mobile mass 110 has at least one receiving surface 110a intended to receive one or more particle(s) to be detected. These particles can, for example, be biological particles such as molecules, virus-like particles (VLPs) or proteins, or particles contained in air or in a gas. When a particle is deposited on the mobile mass 110, adding its mass causes a 25 change of the resonance frequency of the mobile mass 110. This change of frequency is directly linked to the mass of the particle. The mode of detecting the frequency will be detailed further.

In the examples illustrated in FIGS. 1A, 1B, 3A, 3B, 4 and 5, the mobile mass 110 has through openings along the third direction Z. These openings are features of using certain manufacturing methods, but it is understood that they can be absent.

The mechanical sensor 100 further comprises an excitation device 140 capable of vibrating the mobile mass 110 and being able to be of different types.

According to a favoured embodiment, the excitation device 140 is of the electrostatic type. For example, it comprises an electrode located facing an excitation region 113 of the mobile mass 110. By applying a potential difference between the excitation region 113 and the electrode, this potential difference having a constant component and a component varying at a resonance frequency of the mobile mass 110, an electrostatic force appears between the electrode and the mobile mass 110. The latter is thus vibrated at the resonance frequency. As illustrated in FIGS. 1A and 1B, the excitation device 140 can comprise one single electrode. It can be considered, however, that it comprises several of them, for example, two electrodes located on either side of the mobile mass. In this case, phase shift potential differences of a half-period are applied to the two electrodes. The mobile mass 110 can also be electrically connected through anchoring regions 120, in order to ensure its vibration.

According to a variant, the excitation device is of the optical type. It can, for example, comprise a resonating optical resonator, and thus generating a gradient force, making it possible to attract and repel the mobile mass. By modulating the resonance frequency of the optical resonator, and therefore the gradient force, the mobile mass 110 can be vibrated at its or one of its resonance frequency(ies).

According to another variant, the excitation is of the piezoelectric type. The active layer 13 can, for example, be with the basis of a piezoelectric material such as AlN, LNO (LaNiO₃) or LTO (La₂Ti₂O₇). An electric field thus makes it possible to vibrate the mobile mass 110.

FIG. 1B illustrates the system when the mobile mass 110 vibrates under the action of the excitation device 140. The arrow represents the back-and-forth movement of the mobile mass 110.

The system 1 further comprises an optical detector 200 making it possible to detect vibrations, and more specifically, variations of vibration, of the mobile mass. An example of an embodiment of the optical detector 200 will now be described in reference to FIGS. 1A and 1B. The optical detector 200 is not represented in its entirety in FIGS. 2 to 4, but it is understood that its appearance such as represented in FIGS. 1A and 1B and its features described in reference to this same figure apply fully to the invention.

The optical detector 200 typically comprises a waveguide 210, conventionally linear, and an optical resonator 220, for example, ring-shaped—thus, optical ring is referred to—disc-shaped, or more generally, “racetrack” shaped. The waveguide 210 and the optical resonator 220 are coupled by an evanescent coupling.

The waveguide 210 comprises an input 211 and an output 212 between which, when the system is operating, a light radiation, typically a laser radiation, called detection radiation is diffused. The coupling between the waveguide 210 and the optical resonator 220 is such that at least some of the detection radiation is injected into the optical resonator 220, then collected again by the waveguide 210. The vibration of the sensor element 110 in the proximity of the optical resonator 220 causes a modification of the actual optical index of the latter and therefore disrupts the detection radiation passing into the optical resonator 220.

In order to enable the detection of the vibration of the sensor element 110 by the optical detector 200, the optical resonator 220 and the sensor element 110 are positioned, such that at least one part of the sensor element 110 is located in the evanescent field of the optical resonator 220. The distance between the sensor element 110 and the optical resonator 220 can, for example, be around 100 nm. Moreover, the relative arrangement of the optical resonator 220 and of the sensor element 110 is such that when the sensor element 110 vibrates, the distance between these two elements varies and the sensor element 110 remains in the evanescent field of the optical resonator 220.

The optical detector 200 moreover comprises means making it possible to detect the power of the light radiation at the output 212 of the waveguide 210. This power is proportional to the movement of the mobile mass 110. The analysis of the evolution of this power thus makes it possible to determine the resonance frequency of the mobile mass 110 and its evolutions, and therefore to determine the mass of the particle(s) deposited on the latter.

The means for detecting the power of the light radiation can, for example, comprise a spectrometer, a photodetector such as a photodiode, or an external laser and interferometric detection means.

The mobile mass 110 according to the invention has a first region 111, called interaction region 11, and a second region 112. The interaction region 111 is located facing the optical detector 200, and more specifically, facing the optical resonator 220. More specifically, an interaction face 111c of the interaction region 111 is located facing a secondary interaction face 200c of the optical detector 200, and generally of the optical resonator 220. The interaction face 111c thus forms a distal surface of the interaction region 111, which is closest to the optical detector 200; it forms a part at the interface of this resonator. The interaction face 111c typically corresponds to a flank 111c of the interaction region 111. The second region 112 and the optical resonator 220 are located on either side of the interaction region 111.

In order to guarantee that the mass of the mobile mass 110 is sufficiently low, such that the analysis is accurate, while preserving a sufficient high disruption of the optical properties of the optical resonator 220 by the vibration of the mobile mass 110 to guarantee a good detection of said vibration, it is provided that, projecting into the vertical plane XZ, the second region 112 has a surface area S112 less than that of the interaction region 111, referenced S₁₁₁. Projecting into the vertical plane XZ of the interaction region 111 typically corresponds to that of its flank 111c facing the optical resonator 220.

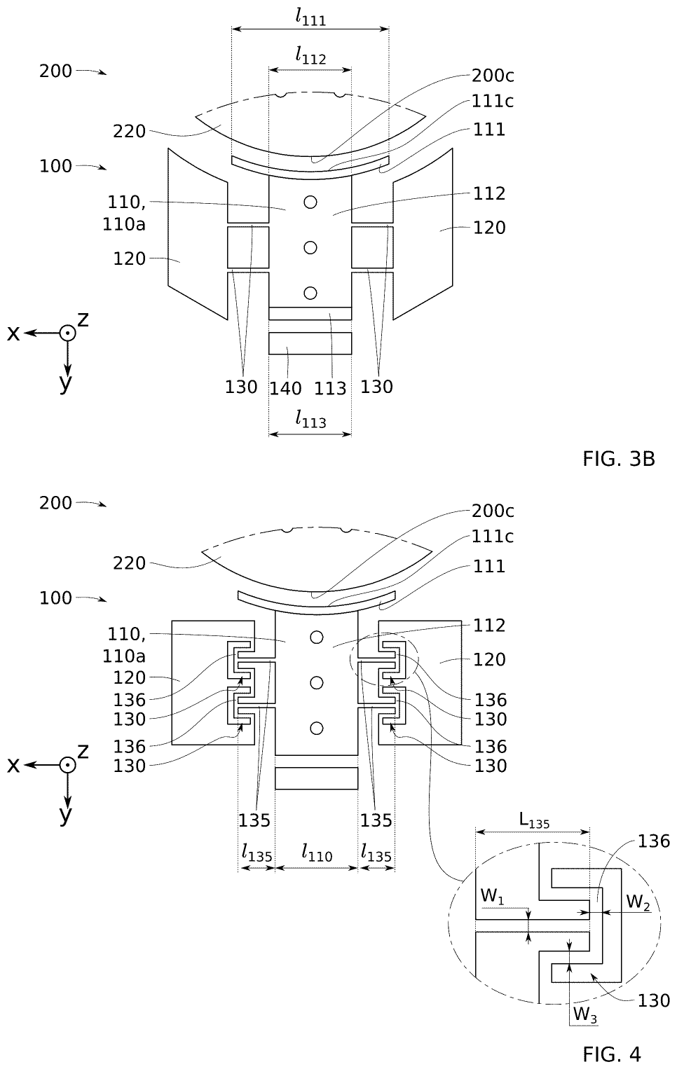

It is provided that the interaction region 111 can have a width l₁₁₁ along the second direction X (see FIGS. 3A and 3B), a height H₁₁₁ along the third direction Z (see FIG. 2), or both a width l₁₁₁ along the second direction X and a height H₁₁₁ along the third direction Z greater than that/those of the second region 112 (i.e. l₁₁₂≥l₁₁₂ and/or H₁₁₁≥H₁₁₂, the case l₁₁₁=l₁₁₂ and H₁₁₁=H₁₁₂ however being excluded). In particular, l₁₁₁>l₁₁₂ and/or H₁₁₁>H₁₁₂ can thus be had.

Advantageously, as illustrated in FIGS. 3A and 3B, the flank 111c of the interaction region 111 located facing the optical detector 200, and more specifically, of the optical resonator 220, has a shape which is complementary to the latter. This makes it possible to maximise the mechanical-optical interaction between the mobile mass 110 and the optical detector 200. For example, when the optical resonator 220 is an optical ring and therefore has a crown shape projecting into the excitation plane XY, or when the optical resonator 220 has a disc shape projecting into the excitation plane XY, it is advantageously provided that the interaction region 111 has a concave shape towards the optical resonator 220, i.e. at its flank 111c.

The mobile mass 110 advantageously comprises a third region called excitation region 113 located facing the excitation device 140. More specifically, a flank 113c of the excitation region 113 located facing the optical resonator 220. The excitation region 113 and the interaction region 111 advantageously located on either side of the second region 112.

In order to balance the mobile mass 110, the excitation region 113 preferably has substantially the same volume as the interaction region 111. Thus, preferably, the excitation region 113 has a width l₁₁₃ along the second direction X (see FIG. 3B), a height H₁₁₃ along the third direction Z (see FIG. 2) or both a width l₁₁₃ along the second direction X and a height H113 along the third direction Z greater than that/those of the second region 112.

The excitation region 113 even advantageously has a shape which is substantially identical to that of the interaction region 111. The mobile mass 110 is thus symmetrical with respect to a plane parallel to the vertical plane XZ.

Advantageously, the flank 113c of the excitation region 113 located facing the excitation device 114 has a shape which is complementary to the latter. This makes it possible to maximise the interaction between these two elements making it possible to vibrate the mobile mass 110, for example, an electrostatic interaction.

The receiving surface 110a of the mobile mass 110 comprises the upper face of each of the regions constituting the mobile mass 110, in particular, the upper face of the interaction region 111, the upper face of the second region 112, and optionally, the upper face of the excitation region 113.

### Preferred Examples of an Embodiment of the Fixing Branches 130

According to a preferred embodiment, the fixing branches 130 have articulations configured to reduce the non-linearity of the movement of the mobile mass 110.

Indeed, in the case of fixing branches 130 constituted of single arms mainly extending along the second direction X, as illustrated in FIGS. 1A, 1B, 3A and 3B, when the mobile mass 110 is vibrated along the excitation direction Y, the arms undergo an elongation which modifies its stiffness, which has the effect of creating non-linearities and of limiting the movement amplitude of the mobile mass 110. The maximum detection signal is thus itself, also limited.

Thus, as illustrated in FIG. 4, each of the fixing branches 130 advantageously comprises an arm 135 and a curved portion 136. The curved portion forms a “U”. More specifically, the curved portion 136 has two curved zones, between which the arm is connected to the curved portion 136. The curved portion 136 is connected to an anchoring zone 120. Advantageously, the mobile mass 110, the arms 135, the curved portions 136 and the anchoring zones 120 are made of one single piece. They can, in particular, be formed during the same manufacturing step and be formed of the same material(s).

Each arm 135 has a length L135 along the second direction X and a width W₁ along the excitation direction Y. Each curved portion 136 has two characteristic dimensions: a width W₂, measured along the second direction X at the part, called main part, of the curved portion 136 to which the arm 135 is connected, and a width W₃ measured along the excitation direction Y at the parts of the curved portion 136 forming the bends with the main part.

The sizing of the fixing branches 120 is, among others, done according to the width l₁₁₀ of the mobile mass, measured along the second direction X. l₁₁₀ is typically between 0.5 and 50 μm. Advantageously, L₁₃₅ is of the same magnitude as l₁₁₀, and therefore, for example, between 0.5 and 50 μm. According to an example, L₁₃₅ is substantially equal to l₁₁₀. Moreover, typically, the widths W₁, W₂ and W₃ are substantially equal. They can each be between 10 and 200 nm.

Such fixing branches 130 make it possible to transform the translation movement of the mobile mass 110 into a rotation movement at the anchoring zones 120. Consequently, there is no elongation of the arm 135 during the vibration of the mobile mass 110, and it is possible to reach greater vibration amplitudes in linear mode.

### System for Detecting Several Mobile masses

According to an advantageous embodiment, the system according to the invention can comprise a plurality of mobile masses 1101, 1102, 1103, each mobile mass 1101, 1102, 1103 being placed so as to modify the evanescent field of the optical detector 200.

These mobile masses are preferably disposed regularly around the optical resonator 220. Preferably, an alternance of mobile masses 1101, 1102, 1103 and of anchoring regions 120 is located around the optical resonator 220. One same anchoring region 120 can serve to anchor two (or more) mobile masses 1101, 1102, 1103.

By vibrating the mobile masses 1101, 1102, 1103 at different resonance frequencies, it is possible after treatment, to separate the impacts of the different mobile masses 1101, 1102, 1103 on the optical properties of the optical detector 200 and thus increase the mass of the particles deposited on each mobile mass 1101, 1102, 1103. Such a system makes it possible to simultaneously detect several particles. This system can thus offer a quicker detection.

### Mass Spectrometer Comprising a System According to the Invention

Another aim of the invention relates to a mass spectrometer comprising a detection system such as described above.

The system can indeed be disposed within a cavity being able to accommodate one or more species to be analysed. Advantageously, it is provided that the particles are driven towards the receiving surface 110a of the mobile mass 110 by a conduit. In the case of a system comprising several mobile masses 1101, 1102, 1103, it can be provided, for example, that the conduit has an opening facing the receiving surface 110a of each mobile mass 1101, 1102, 1103.

The invention is not limited to the embodiments described above and extends to all the embodiments covered by the invention.

1. An optomechanical system for transducing an optical phase shift movement comprising:
a mechanical sensor comprising a mobile mass of which a surface, called receiving surface, is intended to receive one or more particle(s) to be detected and to undergo the weight of the particle(s) to be detected, and an excitation device,
an optical detector comprising an optical resonator, the excitation device being configured to vibrate the mobile mass along a first direction called excitation direction (Y) at at least one of its resonance frequencies, the vibration of the mobile mass being modified by the weight of the particle(s) to be detected, the vibration of the mobile mass modifying an evanescent field of the optical detector,
the mobile mass having a first region called interaction region facing the optical resonator of the optical detector,
wherein the mobile mass comprises at least one second region located outside of the interaction region, the second region and the optical resonator located on either side of the interaction region, the interaction region and the second region respectively having, projecting along a plane perpendicular to the excitation direction (Y), called vertical plane (XZ), an interaction surface area Sin and a second surface area S₁₁₂, the second region being such that S₁₁₁>S₁₁₂, and in that along a third direction (Z) perpendicular to a plane, called excitation plane (XY), parallel to which the receiving surface mainly extends, the interaction region has a height H₁₁₁ and the second region has a height H₁₁₂, with H₁₁₁>H₁₁₂.

2. The system according to claim 1, wherein S₁₁₁>2*S₁₁₂.

3. The system according to claim 1, wherein H₁₁₁>2*H₁₁₂.

4. The system according to claim 1, wherein, along a third direction (Z) perpendicular to a plane, called excitation plane (XY), parallel to which the receiving surface mainly extends, the second region has a height H₁₁₂, with H₁₁₂≤60 nm.

5. The system according to claim 1, wherein, along a second direction (X) parallel to the vertical plane (XZ) and perpendicular to the excitation direction (Y), the interaction region has a width l₁₁₁ and the second region has a width l₁₁₂, with l₁₁₁>1.5*l₁₁₂.

6. The system according to claim 1, wherein, along the excitation direction (Y), the mobile mass has a length L₁₁₀ and the interaction region has a length L₁₁₁, with L₁₁₁≤0.1*L₁₁₀.

7. System The system according to claim 1, wherein the interaction region has an interaction face facing a secondary interaction face of the optical detector, the interaction face and the secondary interaction face having identical shapes projecting into a plane perpendicular to the vertical plane (XZ) and parallel to the excitation direction (Y), called horizontal plane (XY).

8. The system according to claim 7, wherein the interaction face and the secondary interaction face have a circular arc shape projecting into the horizontal plane (XY).

9. The system according to claim 1, wherein the mobile mass has an excitation region facing the excitation device, the excitation region having, projecting along the plane (XZ) perpendicular to the excitation direction (Y), an excitation surface area S₁₁₃ with S₁₁₃>S₁₁₂.

10. The system according to claim 9, wherein the interaction region and the excitation region have substantially identical volumes.

11. The system according to claim 9, wherein the interaction region and the excitation region are located on either side of the second region.

12. The system according to claim 1, wherein the excitation device is an electrode, applying on the mobile mass, an electrostatic force to the resonance frequency(ies) of the mobile mass.

13. A mass spectrometer comprising a cavity configured to accommodate at least one particle, the cavity comprising an optomechanical system according to claim 1, and a light source configured to inject a radiation into the optical detector of the optomechanical system.

14. The mass spectrometer according to claim 13, wherein the cavity further comprises a conduit configured to bring the at least one particle towards the receiving surface of the mobile mass.
